(19) United States
(12) Patent Application Publication
(10) Pub. No.: US 2018/0147722 A1
(43) Pub. Date: May 31, 2018

(54) METHOD AND SYSTEM FOR MANAGING WIRELESS NETWORKING OF UNITS INSIDE ROBOT

(71) Applicant: Nanjing AvatarMind Robot Technology Co., Ltd., Nanjing (CN)

(72) Inventors: Tingliang LI, Nanjing (CN); Zhen LI, Nanjing (CN)

(21) Appl. No.: 15/861,668

(22) Filed: Jan. 4, 2018

Related U.S. Application Data
(63) Continuation of application No. PCT/CN2017/109930, filed on Nov. 8, 2017.

(30) Foreign Application Priority Data
Nov. 30, 2016 (CN) 201611079852.X

(51) Int. Cl. B25J 9/16; G05B 19/418

(52) U.S. Cl. CPC B25J 9/161; B25J 9/1633; G05B 2219/32021; G05B 19/4185; B25J 9/1664

(57) ABSTRACT

The present disclosure discloses a management method and system for wireless networking of units inside a robot. The system includes a control unit and a plurality of tributary units, wherein each tributary unit has a wireless transceiver module, and the units are in wireless communication with each other. With the management method and system for wireless networking of units inside a robot according to the present disclosure, by virtue of the short-range and low-power consumption wireless communication technology, networking is implemented for the units inside the robot to take the place of the communication manner using limited cables, electrical faults caused by wearing and bending of the cables for a long time are removed, safety and reliability of the robot are improved.

### CROSS-REFERENCE OF RELATED APPLICATIONS

This application is a continuation application of international patent application PCT/CN2017/109930, filed on Nov. 8, 2017, which is based upon and claims priority of Chinese Patent Application No. 201611079852.X, filed before Chinese Patent Office on Nov. 30, 2016 and entitled “METHOD AND SYSTEM FOR MANAGING WIRELESS NETWORKING OF UNITS INSIDE ROBOT”, the entire contents of which are incorporated herein by reference.

### TECHNICAL FIELD

The present disclosure relates to the technical field of communications inside a robot, and in particular, relates to a management method and system for wireless networking of units inside a robot.

### BACKGROUND

A robot is generally formed by a plurality of units. To perform corresponding actions, the units need to exchange information with each other. At present, the units inside a robot are connected by virtue of cables, and internal communication between the units is practiced via the cables. Since the robot has to make a large number and long-time joint motions, wear-resistance and anti-bending property of the cables are very important. When being used for a long time, the cables may be somewhat damaged. However, once the cables are damaged, signal transmission may be inevitably affected, such that the robot may not be normally used, and some safety risks may be present. In addition, maintenance of the cables is not simple and convenient, and replacement of the cables is very troublesome. The cables inside the robot also occupy a large space, such that the narrow and small internal space of the robot becomes greatly smaller.

### SUMMARY

The technical problem to be solved by the present disclosure is to provide a method and system for managing wireless networking of units inside a robot. With the method, wireless communication between the units inside the robot may be implemented, internal space of the robot may be saved, loss of components or parts may be reduced, maintenance cost may be lowered, and stability of the robot may be improved.

To achieve the above objectives of the present disclosure, the present disclosure provides a method for managing wireless networking of units inside a robot. The method includes the following steps: S1: sending, by a control unit, a network query instruction to all the tributary units inside the robot after the units inside the robot are initialized; S2: receiving, by the control unit, a query response message sent by each of all the tributary units in a wireless network in response to the network query instruction, and sending a network join instruction to a tributary unit that fails to send the query response message; wherein the query response message includes level assignment information and self-organization information; S3: switching to a network join state by a tributary unit to access the network; wherein the tributary unit to access the network is a tributary unit that receives the network join instruction; S4: detecting, by the tributary unit to access the network, whether a current channel is vacant; S5: sending, by the tributary unit to access the network, an access request message to the control unit if the current channel is vacant; S6: judging, by the tributary unit to access the network, whether level assignment information sent by the control unit is received within a predetermined time period; and S7: upon receiving the level assignment information, sending, by the tributary unit to access the network, the self-organization information to the control unit.

Further, following step S4, the method includes step S41: when the current channel is not vacant, judging, by the tributary unit to access the network, whether the number of consecutive times when the channel is not vacant reaches a predetermined detection count; and step S42: skipping to step S4 after a delay if the number of consecutive times that the channel is not vacant does not reach the predetermined detection count.

Further, following step S41, the method may include step S43: quitting the network join state by the tributary unit to access the network if the number of consecutive times that the channel is not vacant reaches the predetermined detection count.

Further, following step S6, the method include step S61: if the level assignment information sent by the control unit is not received within the predetermined time period, judging, by the tributary unit to access the network, whether the number of consecutive times when the level assignment information sent by the control unit is not received within the predetermined time period reaches a predetermined wait count; and step S62: skipping to step S4 if the number of consecutive times that the level assignment information sent by the control unit is not received within the predetermined time period does not reach the predetermined wait count.

Further, following step S61, the method includes step S63: quitting the network join state by the tributary unit to access the network if the number of consecutive times that the level assignment information sent by the control unit is not received within the predetermined time period reaches the predetermined wait count.

The method further includes the following steps: S90: sending, by the control unit, a network maintain instruction to all the tributary units in the wireless network if a predetermined network maintenance time interval is reached; S91: receiving, by the control unit, feedback information sent by each of all the tributary units in response to the network maintain instruction; and S92: deleting the tributary unit corresponding to the non-normal feedback information from the wireless network if the received feedback information is non-normal feedback information.

Further, following step S91, the method includes the following steps: S93: updating the number of times that the tributary unit fails to send the feedback information if a tributary unit in the wireless network fails to send the feedback information; S94: judging, by the control unit, whether the number of times that the tributary unit fails to send the feedback information reaches a predetermined fail-to-send count; S95: if the number of times that the tributary unit fails to send the feedback information does not reach the predetermined fail-to-send count, sending, by the control unit, the network maintain instruction to the tributary unit of which the number of times that the tributary unit fails to send the feedback information does not reach the predetermined fail-to-send count, and judging whether the feedback information sent by the tributary unit is received; S96: updating the number of times that the tributary unit fails to send the feedback information and performing step S94 if the feedback information sent by the tributary unit is not received; S97: judging whether the feedback information is the non-normal feedback information if the feedback information sent by the tributary unit is received; and S98: deleting, by the control unit, the tributary unit that fails to send the feedback information from the wireless network if the number of times that the tributary unit fails to send the feedback information reaches the predetermined fail-to-send count.

The present disclosure further provides a system for managing wireless networking of units inside a robot. The system includes: a control unit and a plurality of tributary units; wherein the control unit is in wireless communication with each of the tributary units; the control unit is configured to: send a network query instruction to all the tributary units inside the robot after the units inside the robot are initialized; and receive a query response message sent by each of all the tributary units in a wireless network in response to the network query instruction, and sending a network join instruction to a tributary unit that fails to send the query response message; wherein the query response message includes level assignment information and self-organization information; and the system further includes a tributary unit to access the network, configured to switch to a network join state; wherein the tributary unit to access the network is a tributary unit that receives the network join instruction; and wherein the tributary unit to access the network detects whether a current channel is vacant; if the current channel is vacant, the tributary unit to access the network sends an access request message to the control unit, and judge whether level assignment information sent by the control unit is received within a predetermined time period; and if receiving the level assignment information, the tributary unit to access the network sends self-organization information to the control unit.

Further, the tributary unit to access the network is configured to: when the current channel is not vacant, judge whether the number of consecutive times that the channel is not vacant reaches a predetermined detection count; and re-detect whether the current channel is vacant after a delay if the number of consecutive times that the channel is not vacant does not reach the predetermined detection count.

Further, the tributary unit to access the network is configured to: quit the network join state by the tributary unit to access the network if the number of consecutive times that the channel is not vacant reaches the predetermined detection count.

Further, the tributary unit to access the network is configured to: if the level assignment information sent by the control unit is not received within the predetermined time period, judging, by the tributary unit to access the network, whether the number of consecutive times that the level assignment information sent by the control unit is not received within the predetermined time period reaches a predetermined wait count; and re-detect whether the current channel is vacant if the number of consecutive times that the level assignment information sent by the control unit is not received within the predetermined time period does not reach the predetermined wait count.

Further, the tributary unit to access the network is configured to quit the network join state by the tributary unit to access the network if the number of consecutive times that the level assignment information sent by the control unit is not received within the predetermined time period reaches the predetermined wait count.

Further, the control unit is configured to: send a network maintain instruction to all the tributary units in the wireless network if a predetermined network maintenance time interval is reached; receive feedback information sent by each of all the tributary units in response to the network maintain instruction; and if the received feedback information is non-normal feedback information, delete the tributary unit corresponding to the non-normal feedback information from the wireless network.

Further, the control unit is configured to: if a tributary unit in the wireless network fails to send the feedback information, update the number of times that the tributary unit fails to send the feedback information; judge whether the number of times that the tributary unit fails to send the feedback information reaches a predetermined fail-to-send count; and if the number of times that the tributary unit fails to send the feedback information does not reach the predetermined fail-to-send count, send the network maintain instruction to the tributary unit of which the number of times that the tributary unit fails to send the feedback information does not reach the predetermined fail-to-send count, and judge whether the feedback information sent by the tributary unit is received; update the number of times that the tributary unit fails to send the feedback information, and re-judge whether the number of times that the tributary unit fails to send the feedback information reaches the predetermined fail-to-send count, if the feedback information sent by the tributary unit is not received; judge whether the feedback information is the non-normal feedback information if the feedback information sent by the tributary unit is received; and delete the tributary unit that fails to send the feedback information from the wireless network if the number of times that the tributary unit fails to send the feedback information reaches the predetermined fail-to-send count.

With the management method and system for wireless networking of units inside a robot according to the present disclosure, by virtue of the short-range and low-power consumption wireless communication technology, networking is implemented for the units inside the robot to take the place of the communication manner using limited cables, electrical faults caused by wearing and bending of the cables for a long time are removed, safety and reliability of the robot are improved. In addition, the units in the wireless network are capable of directly or indirectly in data communication with each other, the wireless network has the automatic repair function when a unit joins or quits the wireless network. The present disclosure has the advantages of short network delay, quick response, low power consumption, high communication speed, good reliability and high safety.

### BRIEF DESCRIPTION OF THE DRAWINGS

FIG. 1 is a structural topology diagram of a network system according to the present disclosure;

FIG. 2 is a circuit principle diagram of wireless communication subunits;

FIG. 3 is a self-organization flowchart of subsystem nodes;

FIG. 4 is a flowchart of a method for managing wireless networking of units inside a robot according to an embodiment of the present disclosure;

FIG. 5 is a flowchart of a method for managing wireless networking of units inside a robot according to another embodiment of the present disclosure; and

FIG. 6 is a flowchart of partial of a method for managing wireless networking of units inside a robot according to still another embodiment of the present disclosure.

### DETAILED DESCRIPTION

Hereinafter a management method and system for wireless networking of units inside a robot are described in retail with reference to the accompanying drawings.

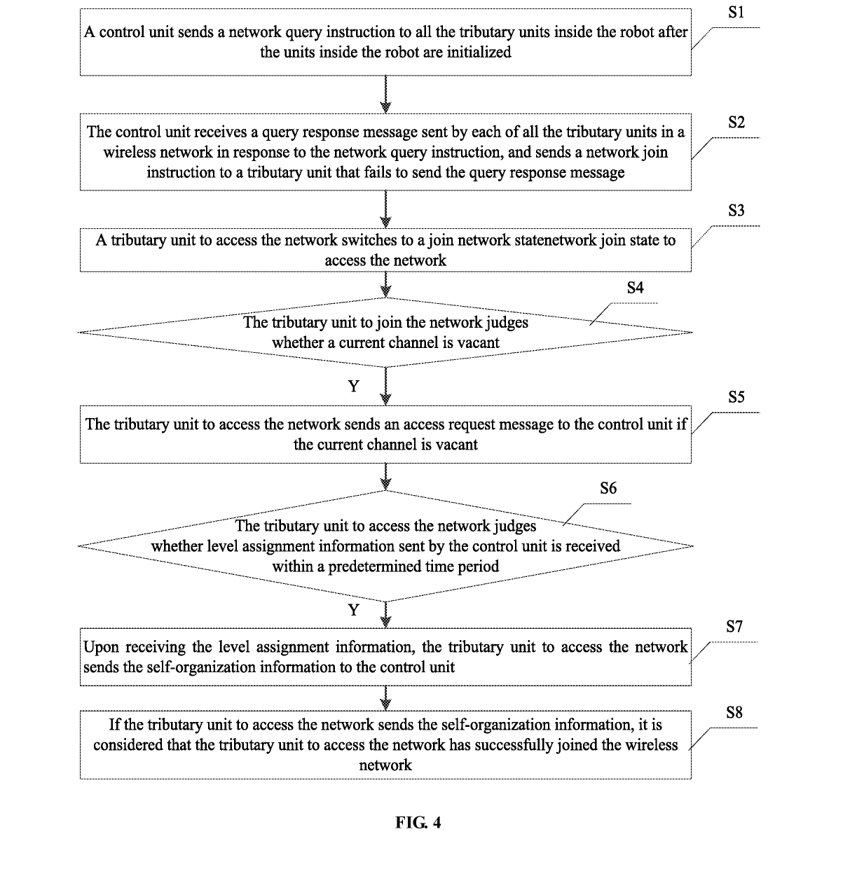

In an embodiment of the present disclosure, as illustrated in FIG. 4, a method for managing wireless networking of units inside a robot includes the following steps:

S1: sending, by a control unit, a network query instruction to all the tributary units inside the robot after the units inside the robot are initialized;

S2: receiving, by the control unit, a query response message sent by each of all the tributary units in a wireless network in response to the network query instruction, and sending a network join instruction to a tributary unit that fails to send the query response message; wherein the query response message includes level assignment information and self-organization information;

S3: switching to a network join state by a tributary unit to access the network;

wherein the tributary unit to access the network is a tributary unit that receives the network join instruction;

S4: detecting, by the tributary unit to access the network, whether a current channel is vacant;

S5: sending, by the tributary unit to access the network, an access request message to the control unit if the current channel is vacant;

S6: judging, by the tributary unit to access the network, whether level assignment information sent by the control unit is received within a predetermined time period;

S7: upon receiving the level assignment information, sending, by the tributary unit to join the network, the self-organization information to the control unit; and

S8: if the tributary unit to access the network sends the self-organization information, considering that the tributary unit to access the network has successfully joined the wireless network.

Specifically, the units inside the robot all have a wireless transceiver module, such that the units may join the same wireless network to implement networking, and the units may perform such operations as sending an instruction, receiving an instruction, feeding back information and the like in the wireless network. In this way, wired communication of the units is converted into wireless communication, thereby saving space and improving signal transmission efficiency.

The networking mode is equivalent to establishing a wireless network by the control unit, such that all the tributary units (the other units except the control unit inside the robot are the tributary units) join the network. In this way, the control unit and the tributary units in the same wireless network perform such operations as receiving and sending an instruction, receiving and sending feedback information and the like.

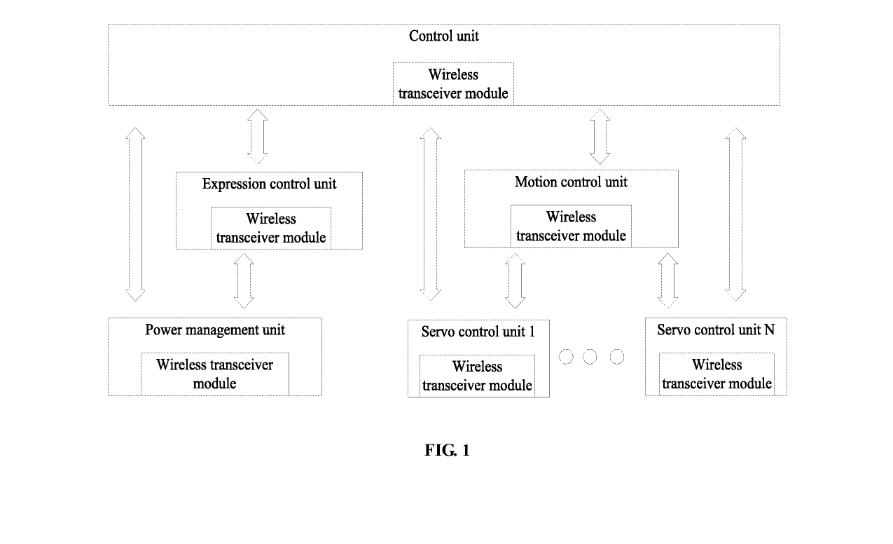

In this embodiment, the wireless network is a layered network. As illustrated in FIG. 1, the control unit is in the top layer, an expression control unit and a motion control unit in the tributary units form an intermediate layer, and a power management unit and various servo control units are in the bottom layer. The control unit in the top layer is capable of directly sending a control and state query instruction to any of the tributary units in the intermediate layer and the bottom layer, and is capable of directly receiving operating state information reported by the tributary units. The expression control unit in the intermediate layer has the rights to send a control and state query instruction to the power management unit in the bottom layer, and receive operating state information reported by the power management unit. The motion control unit in the intermediate layer has the rights to send a control and state query instruction to any of the servo control units in the bottom layer, and receive operating state information reported by the servo control unit.

After the units inside the robots are initialized, the control unit may enter a normal operating state. In this case, the control unit of the robot knows the specific number of tributary units inside the robot by scanning. Upon acknowledgement of the tributary units, the robot may send a network query instruction to the tributary units, to judge whether these tributary units are in the wireless network in which the control unit is located. When sending the network query instruction, the control unit may send the instruction in a broadcast manner.

Upon receiving the network query instruction, the tributary units may perform a corresponding operation according to the current condition thereof. For example, if a tributary unit is in the wireless network in which the control unit is located, this tributary unit may send a query response message to the control unit to notify the control unit that the tributary unit and the control unit are located in the same wireless network, thereby implementing such operations as sending and receiving an instruction, sending and receiving feedback information and the like; and if a tributary unit is not in the wireless network in which the control unit is located, this tributary unit may not send a query response message to the control unit. Therefore, the control unit may acknowledge via the received query response message how many tributary units are not in the wireless network, such that the control unit sends a network join instruction separately to these tributary units that are not in the wireless network.

Hereinafter, description is given using a tributary unit that is not in the wireless network as an example. When there is a plurality of tributary units that are not in the wireless network, each of the tributary units that are not in the wireless network perform the same operation, which is thus not described herein any further.

Upon receiving a network join instruction, the tributary unit that is not in the wireless network may switch to a network join state, that is, may subsequently perform an operation of joining the network according to the network join instruction. For ease of description of the subsequent processes, the tributary unit receiving the network join instruction is referred to as a tributary unit to access the network.

The tributary unit to access the network may perform the following operations to join the network:

(1) The tributary unit to access the network may detect whether the current channel is vacant. If the current channel is vacant, the tributary unit may send an access request message to the control unit. Therefore, the tributary unit to access the network would send the access request message to the control unit only when detecting that the current channel is vacant. The access request message includes: a network access request and a level assignment request.

(2) Upon sending the access request message, the tributary unit may set a timer and enters a low power-consumption state to wait for level assignment information sent by the control unit. That is, the tributary unit to access the network may judge whether the level assignment information sent by the control unit is received within a predetermined time period (that is, a duration set by the timer). The predetermined time period may be set empirically so as to ensure a better networking effect.

(3) If the tributary unit to access the network receives the level assignment information sent by the control unit within the predetermined time period, the control unit has granted the tributary unit to join the wireless network. In this case, the tributary unit to access the network may complete the operation for joining the wireless network as long as the tributary unit sends self-organization information thereof to the control unit.

The level assignment information includes: 1. the control unit may assign a priority to each of the tributary units to prevent data loss caused by simultaneous communication between the tributary units and the control unit, wherein a tributary unit having a high priority takes the precedence to communicate with the control unit over a tributary unit having a low priority; 2. the control unit may also assign level information to each of the tributary units, such that the tributary units acknowledge the levels thereof, know which tributary unit may be controlled, or know which tributary unit controls the others in addition to the control unit.

For example, as illustrated in FIG. 1, the robot includes: a control unit, an expression control unit, a motion control unit, a power management unit, and a plurality of servo control units. The other units except the control unit are all referred to as the tributary units, wherein each of these tributary units has a wireless transceiver module such that each unit has the capability to carry out wireless communication.

Assume that the robot has five servo control units: a servo control unit 1, a servo control unit 2, a servo control unit 3, a servo control unit 4, and a servo control unit 5; and further includes a control unit, an expression control unit, a motion control unit, and a power management unit. Upon sending a network query instruction to all the tributary units, the control unit finds that the expression control unit and the servo control unit 5 fail to send a query response message. Therefore, the control unit sends a network join instruction to the expression control unit and the servo control unit 5. Upon receiving an access request message sent by the expression control unit, the control unit may send level assignment information (for example, high priority, and group A in the intermediate layer) to the expression control unit, whereas previous level assignment information of the power management unit includes low priority and group A in the bottom layer. This indicates that the expression control unit and the power management unit are both in the group A, but the expression control unit is in a layer that is higher than the layer of the power management unit. Therefore, the expression control unit may control the power management unit, whereas the power management unit is in communication with the control unit and is controlled by the control unit, and may be further in communication with the expression control unit and may be controlled by the expression control unit. Upon receiving an access request message sent by the servo control unit 5, the control unit may send level assignment information to the expression control unit (including: high priority and group A in the intermediate layer) and may send level assignment information (including: low priority and group B in the bottom layer) to the servo control unit 5, whereas previous level assignment information of the motion control unit includes high priority and group B in the intermediate layer. This indicates that in addition to being in communication with the control unit and controlled by the control unit, the servo control unit 5 is further in communication with the motion control unit and is controlled by the motion control unit.

Each unit (regardless of whether the control unit or the tributary unit) in the wireless network is referred to as a node.

The self-organization information refers to capability information and current state information of the tributary unit to access the network. For example, the capability information of the servo control unit 2 is controlling motion of one or more joints of the left arm, and the current state information is current voltage and current, angle, speed, torque and the like of the controlled joint of the servo control unit 2.

In this embodiment, communication is carried out by wireless networking, which reduces the maintenance cost.

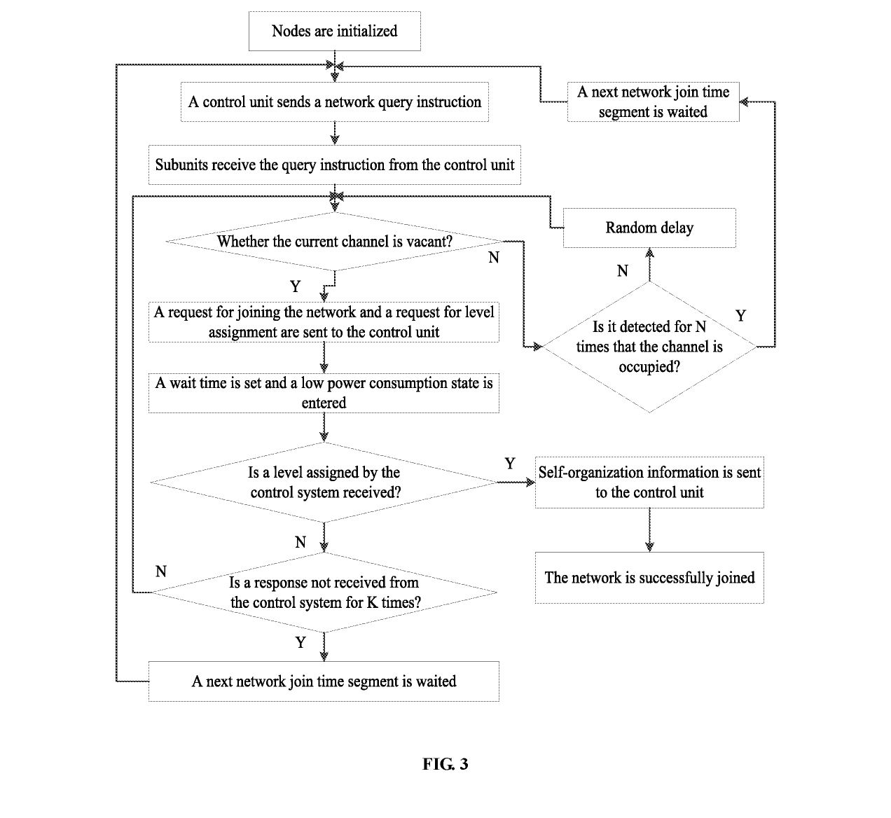

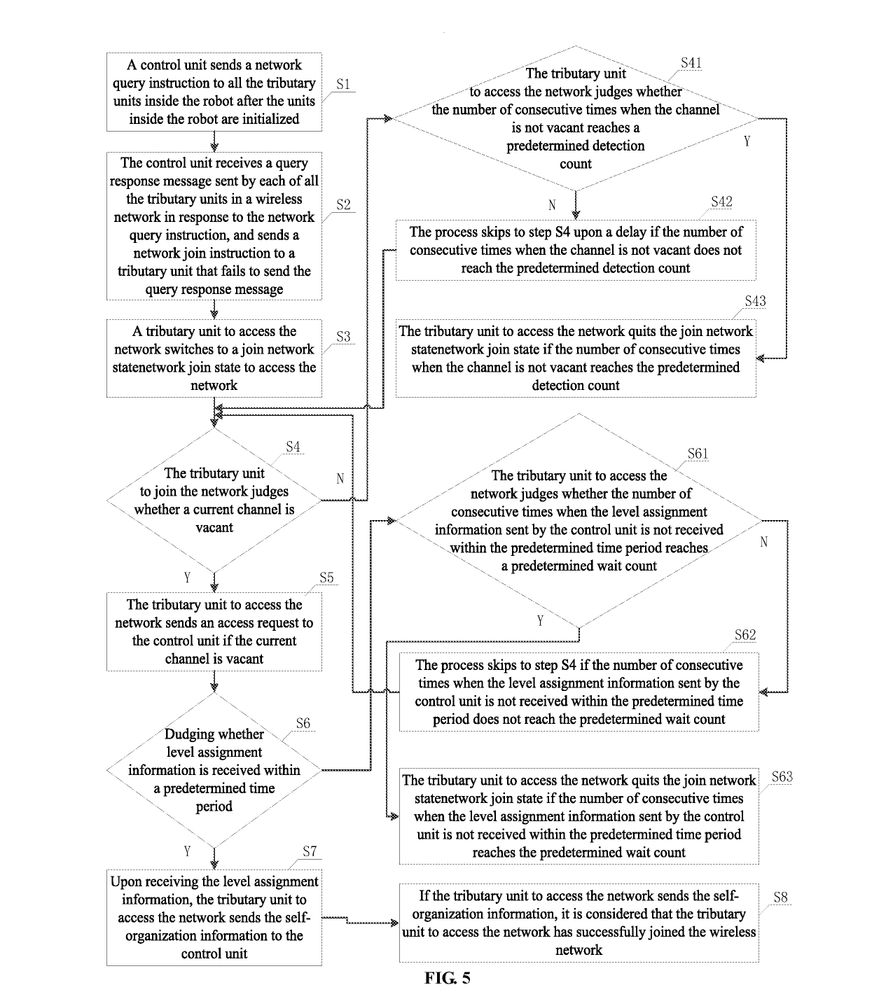

In another embodiment of the present disclosure, based on the above embodiment, as illustrated in FIG. 5 and FIG. 3, following step S4, the method further includes the following steps:

S41: when the current channel is not vacant, judging, by the tributary unit to access the network, whether the number of consecutive times when the channel is not vacant reaches a predetermined detection count; and

S42: skipping to step S4 after a delay if the number of consecutive times that the channel is not vacant does not reach the predetermined detection count.

Specifically, during communication inside the robot, channels may be occupied. Therefore, when the tributary unit to access the network needs to send an access request message to the control unit, the tributary unit may detect whether the current channel is occupied (that is, detecting whether the current channel is null), and re-detect upon a delay of a period of time whether the current channel is occupied if the current channel is occupied.

Each time when the current channel is detected as not vacant (that is, the current channel is constantly occupied), unlimited detections may cause a loss of the system resources. Therefore, a predetermined detection count is defined. When it is detected that the current channel is not vacant, whether the number of consecutive times when the channel is not vacant reaches the predetermined detection count is judged. If the number of consecutive times when the channel is not vacant does not reach the predetermined detection count, detection is performed upon a delay of a period of time. The delay herein may be a random delay, or may be a predetermined wait time defined by engineers empirically, for example, 1 second.

Preferably, following step S41, the method may further include step S43: quitting the network join state by the tributary unit to access the network if the number of consecutive times that the channel is not vacant reaches the predetermined detection count.

Specifically, if the number of consecutive times reaches the predetermined detection count, the tributary unit to access the network may not successfully join the wireless network at this time and quits the network join state, and join the wireless network again when the control unit sends another network query instruction.

It should be noted that, in this embodiment, the number of times when the current channel is consecutively detected to be not vacant is determined. For example, the predetermined detection count is 3, and the number of consecutive times is 1 when the tributary unit to access the network detects at the first time that the current channel is not vacant; the number of consecutive times is updated to 2 when the tributary unit to access the network detects at the second time that the current channel is not vacant upon a delay; the number of consecutive times is updated to an initial value, for example, 0, when the tributary unit to access the network detects that at the third time that the current signal is vacant upon a delay and sends an access request message.

When the tributary unit to access the network quits the network join state because the number of consecutive times when the channel is not vacant reaches the predetermined detection count, the number of consecutive times is updated to the initial value, for example, 0.

In another embodiment of the present disclosure, based on the above embodiment, as illustrated in FIG. 5 and FIG. 3, following step S6, the method further includes the following steps:

S61: if the level assignment information sent by the control unit is not received within the predetermined time period, judging, by the tributary unit to access the network, whether the number of consecutive times when the level assignment information sent by the control unit is not received within the predetermined time period reaches a predetermined wait count; and

S62: skipping to step S4 if the number of consecutive times that the level assignment information sent by the control unit is not received within the predetermined time period does not reach the predetermined wait count.

Specifically, considering that the control unit may receive information fed back by different tributary units, the control unit may take the precedence to process information having a high priority, and therefore may not send level assignment information to the tributary unit to access the network within the predetermined time period.

If the tributary unit to access the network finds that the level assignment information sent by the control unit is not received within the predetermined time period, the tributary unit to access the network may send an access request message again to the control unit to request the control unit to process the request message.

Considering that indefinitely waiting for the level assignment information may cause a loss of the system resources, a predetermined wait count is defined. The predetermined wait count may be defined as different from the predetermined detection count.

Preferably, following step S61, the method further includes step S63: quitting the network join state by the tributary unit to access the network if the number of consecutive times that the level assignment information sent by the control unit is not received within the predetermined time period reaches the predetermined wait count.

Specifically, if the number of consecutive times when the level assignment information sent by the control unit is not received within the predetermined time period reaches the predetermined wait count, the tributary unit to access the network may also quit the network join state, and join the wireless network when the control unit sends another network query instruction.

In this embodiment, examples of determining the number of consecutive times (for ease of subsequent citation or reference, which is referred to as a wait consecutive count) when the level assignment information sent by the control unit is not received within the predetermined time period are as follows: the predetermined wait count is defined as 5; after the tributary unit to access the network sends an access request message, the tributary unit to access the network enters the first wait and finds that the level assignment information is not received, and in this case the wait consecutive count is 1; after the tributary unit to access the network sends an access request message again to the control unit when the current channel is vacant, the tributary unit to access the network enters the second wait and finds that the level assignment information is not received, and in this case the wait consecutive count is 2; after the tributary unit to access the network sends an access request message again when the current channel is vacant, the tributary unit to access the network enters the third wait and finds the level assignment information is not received, and in this case, the wait consecutive count is 3, . . . ; such operations are performed until the wait consecutive count is 5, such that the tributary unit to access the network quits the network join state; and after the tributary unit to access the network quits the network join state, the wait consecutive count is updated to an initial value, for example 0. Nevertheless, after the level assignment information is received, the wait consecutive count may also be updated to the initial value.

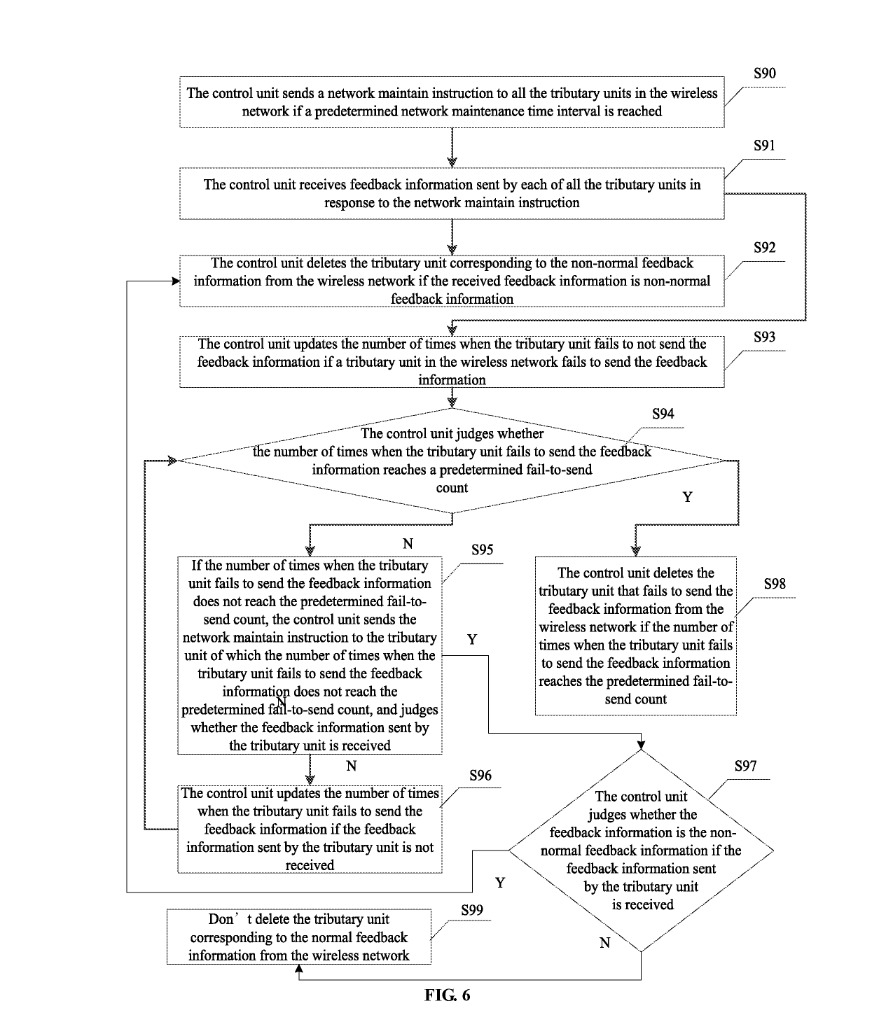

In another embodiment of the present disclosure, based on the above embodiment, as illustrated in FIG. 6, the management method further includes the following steps: S90: sending, by the control unit, a network maintain instruction to all the tributary units in the wireless network if a predetermined network maintenance time interval is reached;

S91: receiving, by the control unit, feedback information sent by each of all the tributary units in response to the network maintain instruction (preferably, the control unit receives feedback information sent by each of the tributary units in response to the network maintain instruction within a predetermined time period, wherein the predetermined time period is set to prevent the control unit from indefinitely waiting for the feedback information); and

S92: deleting the tributary unit corresponding to the non-normal feedback information from the wireless network if the received feedback information is non-normal feedback information.

Specifically, the control unit may periodically maintain the tributary units in the wireless network, to ensure that the tributary units in the wireless network normally operate.

The control unit may send a network maintain instruction to each of the tributary units in the wireless network based on the predetermined network maintenance time interval, each of the tributary units in the wireless network may send feedback information to the control unit in response to the network maintain instruction, and the control unit maintains the wireless network according to the feedback information from the tributary units.

If the feedback information is normal feedback information, for example, voltage or current fed back by the motion control unit which pertains to the normal operating state is normal feedback information, then no operation is performed for the tributary unit feeding back the normal feedback information.

If the feedback information is non-normal feedback information, for example, the servo control unit 2 feeds back that voltage thereof is over-low and a normal servo control operation fails to be performed, or the servo control unit 2 feeds back that a component or part is damaged and thus the servo control unit 2 fails to perform a normal servo control operation or the like, such feedback information from the servo control unit 2 may all be considered as the non-normal feedback information, then the servo control unit 2 is deleted from the wireless network. When the servo control unit 2 is deleted from the wireless network, the control unit may not send a corresponding control instruction to the servo control unit 2.

Preferably, upon step S91, the method further includes the following steps:

S93: updating the number of times that the tributary unit fails to send the feedback information if a tributary unit in the wireless network fails to send the feedback information;

S94: judging, by the control unit, whether the number of times that the tributary unit fails to send the feedback information reaches a predetermined fail-to-send count;

S95: if the number of times that the tributary unit fails to send the feedback information does not reach the predetermined fail-to-send count, sending, by the control unit, the network maintain instruction to the tributary unit of which the number of times that the tributary unit fails to send the feedback information does not reach the predetermined fail-to-send count, and judging whether the feedback information sent by the tributary unit is received;

S96: updating the number of times that the tributary unit fails to send the feedback information and performing step S94 if the feedback information sent by the tributary unit is not received;

S97: judging whether the feedback information is the non-normal feedback information if the feedback information sent by the tributary unit is received; and

S98: deleting, by the control unit, the tributary unit that fails to send the feedback information from the wireless network if the number of times that the tributary unit fails to send the feedback information reaches the predetermined fail-to-send count;

S99: keeping connection with the tributary unit corresponding to the normal feedback information from the wireless network.

Specifically, in some cases, some tributary units are severely damaged or in a power-cutoff state, and may not keep communication with the control unit. Even if the control unit sends a network maintain instruction to these tributary units, the tributary units still fail to receive the instruction, and thus fail to send feedback information. When the control unit finds that a tributary unit fails to send the feedback information, the control unit accordingly acknowledges that this tributary unit fails to operate normally. However, considering that some faults may be automatically repaired, if it is detected that a tributary unit fails to send the feedback information, the control unit may separately send the network maintain instruction cyclically to this tributary unit for many times. If the tributary unit sends the feedback information in response to the network maintain instruction sent subsequently, it is considered that the tributary unit is operating normally. If the tributary unit still fails to send the feedback information, it is considered that the tributary unit fails to normally operate, and the tributary unit may be directly deleted from the wireless network. In this way, a subsequent control instruction does not need to be sent to the tributary unit, and failure to execute the instruction is prevented.

For example, the predetermined network maintenance time interval is 8 hours, and the predetermined fail-to-send count is 5; the control unit sends a network maintain instruction to all the tributary units in the wireless network at an interval of 8 hours, receives feedback information sent by each of the tributary units, and finds that the servo control unit 1 fails to send the feedback information within 1 minute (the predetermined time period), and in this case the control unit updates the number of times when the servo control unit 1 fails to send the feedback information to 1 (an initial value is 0), and judge whether the number of times reaches 5; if the number of times does not reach 5, the control unit separately sends a network maintain instruction to the servo control unit 1 again, and when the servo control unit 1 sends the feedback information in response to this network maintain instruction and the feedback information is normal feedback information, the servo control unit 1 is normally operating, and no operation is performed for the servo control unit 1; when the servo control unit 1 still fails to send the feedback information in response to this network maintain instruction, the control unit updates the number of times when the servo control unit 1 fails to send the feedback information to 2, and separately sends a network maintain instruction again to the servo control unit 1, . . . ; cyclically and repeatedly, if the servo control unit 1 still fails to send the feedback information when the number of times when the servo control unit 1 fails to send the feedback information reaches 5, the control unit deletes the servo control unit 1 from the wireless network.

In the above embodiments, the information and instructions sent by the units are all sent in the form of data packet. Data packet format: In the wireless communication protocols, self-organization of a node is practiced by defining the format and keyword of a data packet; the data packet includes one keyword and date of multiple bytes, wherein self information of the node, data packet length, data route, data check and flag bit information are included, and the keyword represents an attribute of a data packet and differentiate the packet from others, thereby improving communication capability of the network. The information may be encrypted only by modifying the flag bit in the data packet. The self-organization protocol-defined format is as follows:

TABLE 1

| | | | | | | | |
|---|---|---|---|---|---|---|---|
| Pre | Key | Form | Final | Length | Data | Check | Flag |

In Table 1, Pre represents a preamble, it is identified through tests and experiments that signals such as 0xAA and 0x55 that are very regular may not be simply generated in noise, and these character clutters may not be simply generated; Key represents a keyword, which is used to differentiate data packet having different attributes, wherein receiver nodes may respectively enter different data processing units according to the keywords; From represents a source address, which is self information of a sender node; Final represents a destination address of data; Data represents valid data, which employs different formats with variation of the character Key and may carry different information; Check represents a check bit, which may prevent receiving an error data packet; and Flag represents an end flag bit of the data packet. According to the protocol-defined format, Key may partition the data packet carried by the node in communication into: self networking information, environment abrupt variation information, control instructions of the control unit, reported state data of the tributary units, broadcast information, system fault information and the like.

For example, Table 2 lists a data packet format when the control unit sends a control instruction.

TABLE 2

| | | | | | | | | | | | | |
|---|---|---|---|---|---|---|---|---|---|---|---|---|
| 0x55 | 0x55 | 0x20 | 0x01 | 0x07 | 0x01 | 0x0D | 0x11 | 0x01 | 0x10 | 0x06 | 0x08 | 0xAA |

In Table 2, 0x55 and 0x55 represent data preambles, 0x20 represents a join motor driving control instruction directly sent by the control unit to a servo subsystem, 0x01 represents a source address of a sender node of the control unit, 0x07 represents a destination address of the servo subsystem to which the data packet is sent, 0x01 represents a level of the node in the current network, 0x0D represents the number of bytes of the data packet, 0x11 represents a serial number of a joint motor to be driven, 0x01 represents a rotation direction of the joint motor, 0x10 represents an absolute rotation angle of the joint motor, 0x06 represents a rotation speed of the joint motor, 0x08 represents least-significant 8 bits of the front data and acts as a check code of the data packet, and 0xAA represents an end flag bit of the data packet.

A receiver node tributary unit needs to make an acknowledgement (or a response) to a sender node control unit. Table 3 lists a data packet format in case of abrupt variation of the acknowledgement state.

TABLE 3

| | | | | | | | | | |
|---|---|---|---|---|---|---|---|---|---|
| 0x55 | 0x55 | 0x21 | 0x07 | 0x01 | 0x04 | 0x0A | 0x01 | 0xE2 | 0xAA |

In Table 3, 0x21 represents an acknowledge instruction from a subsystem to a primary system, and 0x07 and 0x01 following 0x21 respectively represent an address of the sender node and an address of the receiver node, 0x04 represents a level of the node in the current network, 0x0A represents the number of bytes of the data packet, and 0x01 represents successful execution of the instruction by the subsystem.

A handshake protocol is configured in software design to prevent data loss in serial port communication. Each time when the control unit sends a data packet to a tributary unit, the tributary unit may send an acknowledgement signal to the control signal, until the data packet is sent to the control unit. Upon receiving the data packet, the tributary unit is waken up from a low power consumption mode and performs a corresponding instruction. When a plurality of tributary units are simultaneously in communication with the control unit, the tributary units compete with each other for the channel. To prevent data loss caused by simultaneous communication of the plurality of tributary units with the control unit, a workaround mechanism is configured in software, and the tributary unit having a high level has precedence over the tributary unit having a low level.

In another embodiment of the present disclosure, a system for managing wireless networking of units inside a robot includes: a control unit and a plurality of tributary units; wherein the control unit is in wireless communication with each of the tributary units;

the control unit is configured to: send a network query instruction to all the tributary units inside the robot after the units inside the robot are initialized; and receive a query response message sent by each of all the tributary units in a wireless network in response to the network query instruction, and sending a network join instruction to a tributary unit that fails to send the query response message;

the system further includes a tributary unit to access the network, configured to switch to a network join state; wherein the tributary unit to access the network is a tributary unit that receives the network join instruction; and

wherein the tributary unit to access the network detects whether a current channel is vacant; if the current channel is vacant, the tributary unit to access the network sends an access request message to the control unit, and judge whether level assignment information sent by the control unit is received within a predetermined time period; if receiving the level assignment information, the tributary unit to access the network sends self-organization information to the control unit; and if the tributary unit to access the network sends the self-organization information, it is considered that the tributary unit to access the network has successfully joined the wireless network.

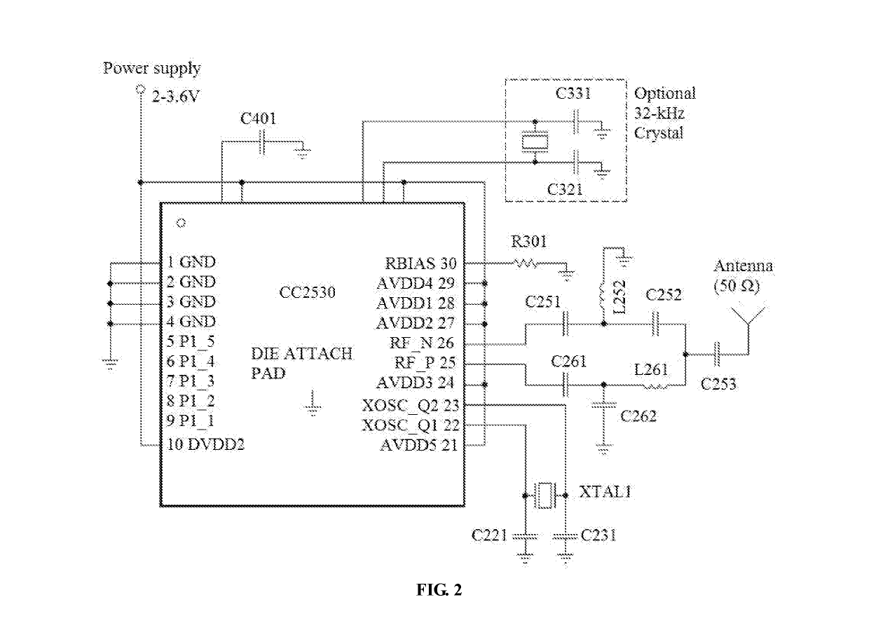

Specifically, as illustrated in FIG. 1, the units inside the robot in this embodiment include: a control unit, a power management unit, a motion control unit, an expression control unit, and a plurality of servo control units; wherein each unit has a wireless transceiver module. FIG. 2 illustrates the circuit diagram of each wireless transceiver module (the wireless transceiver module is differently named from a wireless communication module, but is equivalent to a wireless communication module).

Specifically, the structure of the network system is as follows:

Control unit+wireless transceiver module: mainly formed by a robot artificial intelligence behavior intelligent module, a natural language understanding module, a vision intelligent module, a motion intelligent module, an expression LCD touch display, a body language module, an environment sensing module, and a network knowledge module. The wireless transceiver module is mainly configured to implement wireless communication, send a control instruction of the control unit, and receive operating state reported by each of the tributary units.

Servo control unit N (each servo control unit has the same structure, and N represents the serial number of a service control unit)+wireless transceiver module: The servo control unit is configured to perform the motor control algorithm, periodically acquiring samples of angular operating current and operating temperature of a plurality of brush or brushless servo motors, implement driving and control of the plurality of brush or brushless servo motors according to data feedback from a sensor, periodically detect servo control, judge whether an exceptional event is generated, and prevent such exceptional events as locked rotor, over-current, over-temperature and the like. The wireless transceiver module is mainly configured to receive the control instruction sent by the control unit, and report the operating state thereof to the control unit and/or the motion control unit.

Expression control unit+wireless transceiver module: The expression control unit is under control of the control unit, and configured to control an expression (an LED dot matrix) of the robot; and a microphone array is configured to judge a sound source, and meanwhile read information from the sensors in the head, and sends back the read information. The wireless transceiver module is mainly configured to receive the control instruction sent by the control unit, and report the operating state thereof to the control unit.

Power management unit+wireless transceiver module: The power management unit adjusts in real time a charge current and performs charge management for a battery set according to a maximum charge current and charge current, and a current voltage and temperature of the battery set; and performs discharge management for the battery set according to the current voltage and temperature of the battery set, and power supply of other tributary units, and monitor in real time the temperature, total voltage, single-piece voltage, and power balance of the battery set, the charge current and the discharge current, for calling and decision making by other modules. The wireless transceiver module is mainly configured to receive the control instruction sent by the control unit, and report the operating state thereof to the control unit and/or the expression control unit.

Motion control unit+wireless transceiver module: The motion control unit is under a control center, and is configured to: receive an instruction from the control center, acquire sensor information, control a servo controller, an expression controller and the like, and implement control of the robot; implement initialization of a motion control DSP, initialization of a sensor, and plan processing actions in case of variations of the system state; acquire a basic control instruction, make a comprehensive judgment in combination with feedback by the sensor, and execute the instruction; implement action decomposition in combination with a trajectory control instruction, make a comprehensive judgment in combination with the feedback from the sensor, and issue the basic control instruction; and acquire a task instruction, implement trajectory planning and route planning, make a comprehensive judgment in combination with the feedback from the sensor, and execute the instruction. The wireless transceiver module is mainly configured to receive the control instruction sent by the control unit, and report operating state thereof to the control unit.

The above control instructions and operating states may be sent and received only when the units are in the same wireless network, thereby ensuring normal operating of the robot. Therefore, this embodiment specifically illustrates the process in which the units join the same wireless network.

In this embodiment, the networking mode is equivalent to establishing a wireless network by the control unit, such that all the tributary units (the other units except the control unit inside the robot are the tributary units) join the network. In this way, the control unit and the tributary units in the same wireless network perform such operations as receiving and sending an instruction, receiving and sending feedback information and the like.

In this embodiment, the wireless network is a layered network. As illustrated in FIG. 1, the control unit is in the top layer, an expression control unit and a motion control unit in the tributary units form an intermediate layer, and a power management unit and various servo control units are in the bottom layer. The control unit in the top layer is capable of directly sending a control and state query instruction to any of the tributary units in the intermediate layer and the bottom layer, and is capable of directly receiving operating state information reported by the tributary units. The expression control unit in the intermediate layer has the rights to send a control and state query instruction to the power management unit in the bottom layer, and receive operating state information reported by the power management unit. The motion control unit in the intermediate layer has the rights to send a control and state query instruction to any of the servo control units in the bottom layer, and receive operating state information reported by the servo control unit.

After the units inside the robots are initialized, the control unit may enter a normal operating state. In this case, the control unit of the robot knows the specific number of tributary units inside the robot by scanning. Upon acknowledgement of the tributary units, the robot may send a network query instruction to the tributary units, to judge whether these tributary units are in the wireless network in which the control unit is located. When sending the network query instruction, the control unit may send the instruction in a broadcast manner.

Upon receiving the network query instruction, the tributary units may perform a corresponding operation according to the current condition thereof. For example, if a tributary unit is in the wireless network in which the control unit is located, this tributary unit may send a query response message to the control unit to notify the control unit that the tributary unit and the control unit are located in the same wireless network, thereby implementing such operations as sending and receiving an instruction, sending and receiving feedback information and the like; and if a tributary unit is not in the wireless network in which the control unit is located, this tributary unit may not send a query response message to the control unit. Therefore, the control unit may acknowledge via the received query response message how many tributary units are not in the wireless network, such that the control unit sends a join network instruction separately to these tributary units that are not in the wireless network.

Hereinafter, description is given using a tributary unit that is not in the wireless network as an example. When there are a plurality of tributary units that are not in the wireless network, each of the tributary units that are not in the wireless network perform the same operation, which is thus not described herein any further.

Upon receiving a network join instruction, the tributary unit that is not in the wireless network may switch to a network join state, that is, may subsequently perform an operation of joining the network according to the network join instruction. For ease of description of the subsequent processes, the tributary unit receiving the network join instruction is referred to as a tributary unit to access the network.

The tributary unit to access the network may perform the following operations for joining the network:

(1) The tributary unit to access the network may detect whether the current channel is vacant. If the current channel is vacant, the tributary unit may send an access request message to the control unit. Therefore, the tributary unit to access the network would send the access request message to the control unit only when detecting that the current channel is vacant. The access request message includes: a network access request and a level assignment request.

(2) Upon sending the access request message, the tributary unit may set a timer and enters a low power-consumption state to wait for level assignment information sent by the control unit. That is, the tributary unit to access the network may judge whether the level assignment information sent by the control unit is received within a predetermined time period (that is, a duration set by the timer). The predetermined time period may be set empirically so as to ensure a better networking effect.

(3) If the tributary unit to access the network receives the level assignment information sent by the control unit within the predetermined time period, the control unit has granted the tributary unit to join the wireless network. In this case, the tributary unit to access the network may complete the operation for joining the wireless network as long as the tributary unit sends self-organization information thereof to the control unit.

The level assignment information includes: 1. the control unit may assign a priority to each of the tributary units to prevent data loss caused by simultaneous communication between the tributary units and the control unit, wherein a tributary unit having a high priority takes the precedence to communicate with the control unit over a tributary unit having a low priority; 2. the control unit may also assign level information to each of the tributary units, such that the tributary units acknowledge the levels thereof, know which tributary unit may be controlled, or know which tributary unit controls the others in addition to the control unit.

For example, as illustrated in FIG. 1, the robot includes: a control unit, an expression control unit, a motion control unit, a power management unit, and a plurality of servo control units. The other units except the control unit are all referred to as the tributary units, wherein each of these tributary units has a wireless transceiver module such that each unit has the capability to carry out wireless communication.

Assume that the robot has five servo control units: a servo control unit 1, a servo control unit 2, a servo control unit 3, a servo control unit 4, and a servo control unit 5; and further includes a control unit, an expression control unit, a motion control unit, and a power management unit. Upon sending a network query instruction to all the tributary units, the control unit finds that the power management unit fails to send a query response message. Therefore, the control unit sends a network join instruction to the power management unit, and the power management unit performs the subsequent network join operation as the tributary unit to access the network. Upon receiving an access request message sent by the power management unit, the control unit may send level assignment information (for example, low priority, and group A in the bottom layer) to the power management unit, whereas previous level assignment information of the expression control unit includes high priority and group A in the intermediate layer. This indicates that the expression control unit and the power management unit are both in the group A, but the expression control unit is in a layer that is higher than the layer of the power management unit. Therefore, the expression control unit may control the power management unit, whereas the power management unit is in communication with the control unit and is controlled by the control unit, and may be further in communication with the expression control unit and may be controlled by the expression control unit.

Each unit (regardless of whether the control unit or the tributary unit) in the wireless network is referred to as a node.

The self-organization information refers to capability information and current state information of the tributary unit to access the network. For example, the capability information of the servo control unit 3 is controlling motion of one or more joints of the right arm, and the current state information is current voltage and current, angle, speed, torque and the like of the controlled joint of the servo control unit 3.

In this embodiment, by virtue of the control unit, the tributary units join the wireless network, such that signal wireless communicative transmission is implemented between the units, and normal operation of the robot is ensured. Since no cable is used, space inside the robot is greatly saved, loss of loss of components or parts is reduced, maintenance cost is lowered.

In another embodiment of the present disclosure, based on the above embodiment, the tributary unit to access the network is further configured to: when the current channel is not vacant, judge whether the number of consecutive times that the channel is not vacant reaches a predetermined detection count; and re-detect whether the current channel is vacant after a delay if the number of consecutive times that the channel is not vacant does not reach the predetermined detection count.

Specifically, during communication inside the robot, channels may be occupied. Therefore, when the tributary unit to access the network needs to send an access request message to the control unit, the tributary unit may detect whether the current channel is occupied (that is, detecting whether the current channel is null), and re-detect upon a delay of a period of time whether the current channel is occupied if the current channel is occupied.

Each time when the current channel is detected as not vacant (that is, the current channel is constantly occupied), unlimited detections may cause a loss of the system resources. Therefore, a pre-detection count is defined. When it is detected that the current channel is not vacant, whether the number of consecutive times when the channel is not vacant reaches the predetermined detection count is judged. If the number of consecutive times when the channel is not vacant does not reach the predetermined detection count, detection is performed a period of time later. The delay herein may be a random delay, or may be a predetermined wait time defined by engineers empirically, for example, 1.5 seconds.

Preferably, the tributary unit to access the network is further configured to: quit the network join state by the tributary unit to access the network if the number of consecutive times that the channel is not vacant reaches the predetermined detection count.

Specifically, if the number of consecutive times reaches the predetermined detection count, the tributary unit to access the network may not successfully join the wireless network at this time and quits the network join state, and join the wireless network again when the control unit sends another network query instruction.

It should be noted that, in this embodiment, the number of times when the current channel is consecutively detected to be not vacant is determined. For example, the predetermined detection count is 3, and the number of consecutive times is 1 when the tributary unit to access the network detects at the first time that the current channel is not vacant; the number of consecutive times is updated to 2 when the tributary unit to access the network detects at the second time that the current channel is not vacant upon a delay; the number of consecutive times is updated to an initial value, for example, 0, when the tributary unit to access the network detects that at the third time that the current signal is vacant upon a delay and sends an access request message.

When the tributary unit to access the network quits the network join state because the number of consecutive times when the channel is not vacant reaches the predetermined detection count, the number of consecutive times is also updated to the initial value, for example, 0.

In another embodiment of the present disclosure, based on the above embodiment, the tributary unit to access the network is further configured to: if the level assignment information sent by the control unit is not received within the predetermined time period, judging, by the tributary unit to access the network, whether the number of consecutive times that the level assignment information sent by the control unit is received within the predetermined time period reaches a predetermined wait count; and re-detect whether the current channel is vacant if the number of consecutive times that the level assignment information sent by the control unit is received within the predetermined time period does not reach the predetermined wait count.

Specifically, considering that the control unit may receive information fed back by different tributary units, the control unit may take the precedence to process information having a high priority, and therefore may not send level assignment information to the tributary unit to access the network within the predetermined time period.

If the tributary unit to access the network finds that the level assignment information sent by the control unit is not received within the predetermined time period, the tributary unit to access the network may send an access request message again to the control unit to request the control unit to process the request message.

Considering that indefinitely waiting for the level assignment information may cause a loss of the system resources, a predetermined wait count is defined. The predetermined wait count may be defined as different from the predetermined detection count.

Preferably the tributary unit to access the network is further configured to quit the join network state by the tributary unit to access the network if the number of consecutive times when the level assignment information sent by the control unit is received within the predetermined time period reaches the predetermined wait count.

Specifically, if the number of consecutive times when the level assignment information sent by the control unit is not received within the predetermined time period reaches the predetermined wait count, the tributary unit to access the network may also quit the network join state, and join the wireless network when the control unit sends another network query instruction.

In this embodiment, determination of the number of consecutive times when the level assignment information sent by the control unit is not received within the predetermined time period may be referenced to the corresponding method embodiment, which is thus not described herein any further.

In another embodiment of the present disclosure, the control unit is further configured to: send a network maintain instruction to all the tributary units in the wireless network if a predetermined network maintenance time interval is reached;

receive feedback information sent by each of all the tributary units in response to the network maintain instruction; and

if the received feedback information is non-normal feedback information, delete the tributary unit corresponding to the non-normal feedback information from the wireless network.

Specifically, the control unit may periodically maintain the tributary units in the wireless network, to ensure that the tributary units in the wireless network normally operate.

The control unit may send a network maintain instruction to each of the tributary units in the wireless network based on the predetermined network maintenance time interval, each of the tributary units in the wireless network may send feedback information to the control unit in response to the network maintain instruction, and the control unit maintains the wireless network according to the feedback information from the tributary units.

If the feedback information is normal feedback information, for example, voltage or current fed back by the motion control unit which pertains to the normal operating state is normal feedback information, then no operation is performed for the tributary unit feeding back the normal feedback information.

If the feedback information is non-normal feedback information, for example, the servo control unit 2 feeds back that voltage thereof is over-low and a normal servo control operation fails to be performed, or the servo control unit 2 feeds back that a component or part is damaged and thus the servo control unit 2 fails to perform a normal servo control operation or the like, such feedback information from the servo control unit 2 may all be considered as the non-normal feedback information, then the servo control unit 2 is deleted from the wireless network. When the servo control unit 2 is deleted from the wireless network, the control unit may not send a corresponding control instruction to the servo control unit 2.

Preferably, the control unit is further configured to: if a tributary unit in the wireless network fails to send the feedback information, update the number of times when the tributary unit fails to send the feedback information;

judge whether the number of times when the tributary unit fails to send the feedback information reaches a predetermined fail-to-send count;

if the number of times when the tributary unit fails to send the feedback information does not reach the predetermined fail-to-send count, send the network maintain instruction to the tributary unit of which the number of times when the tributary unit fails to send the feedback information does not reach the predetermined fail-to-send count, and judge whether the feedback information sent by the tributary unit is received;

update the number of times when the tributary unit fails to send the feedback information, and re-judge whether the number of times that the tributary unit fails to send the feedback information reaches the predetermined fail-to-send count, if the feedback information sent by the tributary unit is not received;

judge whether the feedback information is the non-normal feedback information if the feedback information sent by the tributary unit is received; and

delete the tributary unit that fails to send the feedback information from the wireless network if the number of times that the tributary unit fails to send the feedback information reaches the predetermined fail-to-send count.

Specifically, in some cases, some tributary units are severely damaged or in a power-cutoff state, and may not keep communication with the control unit. Even if the control unit sends a network maintain instruction to these tributary units, the tributary units still fail to receive the instruction, and thus fail to send feedback information. When the control unit finds that a tributary unit fails to send the feedback information, the control unit accordingly acknowledges that this tributary unit fails to operate normally. However, considering that some faults may be automatically repaired, if it is detected that a tributary unit fails to send the feedback information, the control unit may separately send the network maintain instruction cyclically to this tributary unit for many times. If the tributary unit sends the feedback information in response to the network maintain instruction sent subsequently, it is considered that the tributary unit is operating normally. If the tributary unit still fails to send the feedback information, it is considered that the tributary unit fails to normally operate, and the tributary unit may be directly deleted from the wireless network. In this way, a subsequent control instruction does not need to be sent to the tributary unit, and failure to execute the instruction is prevented.

In the above embodiments, the information and instructions sent by the units are all sent in the form of data packet. The definition of the data packet may be referenced to the above method embodiment, which is not described herein any further.

In this embodiment, by virtue of the short-range and low-power consumption wireless communication technology, networking is implemented for the units inside the robot to take the place of the communication manner using limited cables, electrical faults caused by wearing and bending of the cables for a long time are removed, safety and reliability of the robot are improved. In addition, the units in the wireless network are capable of directly or indirectly in data communication with each other, the wireless network has the automatic repair function when a unit joins or quits the wireless network. The present disclosure has the advantages of short network delay, quick response, low power consumption, high communication speed, good reliability and high safety.

The above embodiments are merely used to illustrate the technical solutions of the present disclosure, instead of limiting the protection scope of the present disclosure. Any modification, equivalent replacement, or improvement made without departing from the spirit and principle of the present disclosure should fall within the protection scope defined by the appended claims of the present disclosure.

What is claimed is:

1. A method for managing wireless networking of units inside a robot, comprising the following steps:
S1: sending, by a control unit, a network query instruction to all the tributary units inside the robot after the units inside the robot are initialized;
S2: receiving, by the control unit, a query response message sent by each of all the tributary units in a wireless network in response to the network query instruction, and sending a network join instruction to a tributary unit that fails to send the query response message;
wherein the query response message comprises level assignment information and self-organization information;
S3: switching to a network join state by a tributary unit to access the network;
wherein the tributary unit to access the network is a tributary unit that receives the network join instruction;
S4: detecting, by the tributary unit to access the network, whether a current channel is vacant;
S5: sending, by the tributary unit to access the network, an access request message to the control unit if the current channel is vacant;
S6: judging, by the tributary unit to access the network, whether level assignment information sent by the control unit is received within a predetermined time period; and
S7: upon receiving the level assignment information, sending, by the tributary unit to access the network, the self-organization information to the control unit.

2. The method for managing wireless networking of units inside a robot according to claim 1, following step S4, the method further comprises the following steps:
S41: when the current channel is not vacant, judging, by the tributary unit to access the network, whether the number of consecutive times when the channel is not vacant reaches a predetermined detection count; and
S42: skipping to step S4 after a delay if the number of consecutive times that the channel is not vacant does not reach the predetermined detection count.

3. The method for managing wireless networking of units inside a robot according to claim 2, following step S41, the method further comprises the following steps:
S43: quitting the network join state by the tributary unit to access the network if the number of consecutive times that the channel is not vacant reaches the predetermined detection count.

4. The method for managing wireless networking of units inside a robot according to claim 1, following step S6, the method further comprises the following steps:
S61: if the level assignment information sent by the control unit is not received within the predetermined time period, judging, by the tributary unit to access the network, whether the number of consecutive times when the level assignment information sent by the control unit is not received within the predetermined time period reaches a predetermined wait count; and
S62: skipping to step S4 if the number of consecutive times that the level assignment information sent by the control unit is not received within the predetermined time period does not reach the predetermined wait count.

5. The method for managing wireless networking of units inside a robot according to claim 4, following step S61, the method further comprises the following steps:
S63: quitting the network join state by the tributary unit to access the network if the number of consecutive times that the level assignment information sent by the control unit is not received within the predetermined time period reaches the predetermined wait count.

6. The method for managing wireless networking of units inside a robot according to claim 1, further comprising the following steps:
S90: sending, by the control unit, a network maintain instruction to all the tributary units in the wireless network if a predetermined network maintenance time interval is reached;
S91: receiving, by the control unit, feedback information sent by each of all the tributary units in response to the network maintain instruction; and
S92: deleting the tributary unit corresponding to the non-normal feedback information from the wireless network if the received feedback information is non-normal feedback information.

7. The method for managing wireless networking of units inside a robot according to claim 6, following step S91, the method further comprises the following steps:
S93: updating the number of times that the tributary unit fails to send the feedback information if a tributary unit in the wireless network fails to send the feedback information;
S94: judging, by the control unit, whether the number of times that the tributary unit fails to send the feedback information reaches a predetermined fail-to-send count;
S95: if the number of times that the tributary unit fails to send the feedback information does not reach the predetermined fail-to-send count, sending, by the control unit, the network maintain instruction to the tributary unit of which the number of times that the tributary unit fails to send the feedback information does not reach the predetermined fail-to-send count, and judging whether the feedback information sent by the tributary unit is received;
S96: updating the number of times that the tributary unit fails to send the feedback information and performing step S94 if the feedback information sent by the tributary unit is not received;
S97: judging whether the feedback information is the non-normal feedback information if the feedback information sent by the tributary unit is received; and
S98: deleting, by the control unit, the tributary unit that fails to send the feedback information from the wireless network if the number of times that the tributary unit fails to send the feedback information reaches the predetermined fail-to-send count.

8. A system for managing wireless networking of units inside a robot, comprising: a control unit and a plurality of tributary units; wherein the control unit is in wireless communication with each of the tributary units;
the control unit is configured to: send a network query instruction to all the tributary units inside the robot after the units inside the robot are initialized; and receive a query response message sent by each of all the tributary units in a wireless network in response to the network query instruction, and sending a network join instruction to a tributary unit that fails to send the query response message;
wherein the query response message comprises level assignment information and self-organization information; and
the system further comprises a tributary unit to access the network, configured to switch to a network join state; wherein the tributary unit to access the network is a tributary unit that receives the network join instruction; and
wherein the tributary unit to access the network detects whether a current channel is vacant; if the current channel is vacant, the tributary unit to access the network sends an access request message to the control unit, and judge whether level assignment information sent by the control unit is received within a predetermined time period; and if receiving the level assignment information, the tributary unit to access the network sends self-organization information to the control unit.

9. The system for managing wireless networking of units inside a robot according to claim 8, wherein
the tributary unit to access the network is further configured to: when the current channel is not vacant, judge whether the number of consecutive times that the channel is not vacant reaches a predetermined detection count; and re-detect whether the current channel is vacant after a delay if the number of consecutive times that the channel is not vacant does not reach the predetermined detection count.

10. The system for managing wireless networking of units inside a robot according to claim 9, wherein
the tributary unit to access the network is further configured to: quit the network join state by the tributary unit to access the network if the number of consecutive times that the channel is not vacant reaches the predetermined detection count.

11. The system for managing wireless networking of units inside a robot according to claim 8, wherein
the tributary unit to access the network is further configured to: if the level assignment information sent by the control unit is not received within the predetermined time period, judging, by the tributary unit to access the network, whether the number of consecutive times that the level assignment information sent by the control unit is not received within the predetermined time period reaches a predetermined wait count; and re-detect whether the current channel is vacant if the number of consecutive times that the level assignment information sent by the control unit is not received within the predetermined time period does not reach the predetermined wait count.

12. The system for managing wireless networking of units inside a robot according to claim 11, wherein
the tributary unit to access the network is further configured to quit the network join state by the tributary unit to access the network if the number of consecutive times that the level assignment information sent by the control unit is not received within the predetermined time period reaches the predetermined wait count.

13. The system for managing wireless networking of units inside a robot according to claim 8, wherein
the control unit is further configured to: send a network maintain instruction to all the tributary units in the wireless network if a predetermined network maintenance time interval is reached;
receive feedback information sent by each of all the tributary units in response to the network maintain instruction; and
if the received feedback information is non-normal feedback information, delete the tributary unit corresponding to the non-normal feedback information from the wireless network.

14. The system for managing wireless networking of units inside a robot according to claim 13, wherein
the control unit is further configured to: if a tributary unit in the wireless network fails to send the feedback information, update the number of times that the tributary unit fails to send the feedback information;
judge whether the number of times that the tributary unit fails to send the feedback information reaches a predetermined fail-to-send count;
if the number of times that the tributary unit fails to send the feedback information does not reach the predetermined fail-to-send count, send the network maintain instruction to the tributary unit of which the number of times that the tributary unit fails to send the feedback information does not reach the predetermined fail-to-send count, and judge whether the feedback information sent by the tributary unit is received;
update the number of times that the tributary unit fails to send the feedback information, and re-judge whether the number of times that the tributary unit fails to send the feedback information reaches the predetermined fail-to-send count, if the feedback information sent by the tributary unit is not received;
judge whether the feedback information is the non-normal feedback information if the feedback information sent by the tributary unit is received; and
delete the tributary unit that fails to send the feedback information from the wireless network if the number of times that the tributary unit fails to send the feedback information reaches the predetermined fail-to-send count.
